(19) United States
(12) Patent Application Publication
(10) Pub. No.: US 2026/0368557 A1
(43) Pub. Date: Nov. 19, 2026

(54) Methods and Systems for Fast Inference from Machine Learning Models

(71) Applicant: Google LLC, Mountain View, CA (US)

(72) Inventors: Yaniv Leviathan, Menlo Park, CA (US); Matan Kalman, Sunnyvale, CA (US); Yossi Matias, Tel Aviv (IL)

(21) Appl. No.: 19/133,562

(22) PCT Filed: Nov. 28, 2023
(86) PCT No.: PCT/US2023/081347

§ 371 Date: May 28, 2025

Related U.S. Application Data
(60) Provisional application No. 63/385,241, filed on Nov. 29, 2022.

(51) Int. Cl. G06N 5/04

(52) U.S. Cl. CPC G06N 5/04

(57) ABSTRACT

An example method includes receiving, by a primary machine learning (ML) model, an input prompt corresponding to a task. The primary model is trained to iteratively generate an output token string. The method includes receiving, from an approximating ML model, a candidate token to be evaluated for appending to an initial prefix. The candidate token is determined by the approximating model by sampling from an approximating distribution. The approximating distribution is conditioned on the initial prefix. The method includes speculatively determining, based on the candidate token appended to the initial prefix, a target distribution for a next token to be appended to the initial prefix. The method includes comparing the approximating distribution and the target distribution. The comparing comprises determining whether the approximating distribution is within a predetermined factor of the target distribution. The method includes providing, based on the comparing, an iteration of the output token string.

### CROSS REFERENCE TO RELATED APPLICATIONS

This application claims priority to U.S. Provisional Application Ser. No. 63/385,241 filed Nov. 29, 2022, the contents of which are incorporated by reference herein.

### BACKGROUND

Tokens may be output by machine learning models (e.g., natural language processing models). Individual tokens may be determined based on rules. Autoregressive models, such as transformers, may output tokens iteratively.

### SUMMARY

Inference from large autoregressive models like transformers can be slow. For example, decoding K tokens may involve K serial runs of the model. Generally, challenging tasks, such as, for example, language-modeling tasks, can involve less challenging subtasks that can be approximated well by efficient models. As described herein, models, such as autoregressive models, may be configured for faster sampling without changing a distribution of the outputs. In some embodiments, this may be achieved by computing multiple tokens in parallel, instead of serial computations. For example, speculative execution and a sampling method may be used to make decoding from the large models more efficient, by running them in parallel on outputs of an approximation model. The approximation model may generate multiple tokens concurrently or iteratively without changing the distribution of the outputs. In some embodiments, existing models (e.g., off-the-shelf models) may be utilized without retraining and/or changes to the computing architecture. Generally, speculative decoding as described herein maintains the overall output distribution for the target model regardless of the approximation model used.

In a first example embodiment, a method may include receiving, by a primary machine learning (ML) model, an input prompt corresponding to a task, wherein the primary ML model is trained to iteratively generate an output token string in response to the input prompt. The method may include receiving, by the primary ML model and from an approximating ML model, a candidate token to be evaluated for appending to an initial prefix of the iteratively output token string, wherein the candidate token is determined by the approximating ML model by sampling from an approximating distribution, and wherein the approximating distribution is conditioned on the initial prefix. The method may also include speculatively determining, by the primary ML model and based on the candidate token appended to the initial prefix, a target distribution for a next token to be appended to the initial prefix. The method may additionally include comparing, by the primary ML model, the approximating distribution and the target distribution, wherein the comparing comprises determining whether the approximating distribution is within a predetermined factor of the target distribution. The method may also include providing, by the primary ML model and based on the comparing, an iteration of the output token string.

In a second example embodiment, a system may include a primary machine learning (ML) model configured to iteratively generate an output token string in response to the input prompt corresponding to a task. The system may also include an approximating ML model. The system may further include a processor and data storage having stored thereon computer-executable instructions that, when executed by the processor, cause the system to carry out functions. The functions may include receiving, by the primary ML model, the input prompt corresponding to the task. The functions may include determining, by the approximating ML model, an approximating distribution conditioned on an initial prefix of the iteratively output token string. The functions may also include determining, by the approximating ML model and by sampling from the approximating distribution, a candidate token to be evaluated for appending to the initial prefix. The functions may further include speculatively determining, by the primary ML model and based on the candidate token appended to the initial prefix, a target distribution for a next token to be appended to the initial prefix. The functions may additionally include comparing, by the primary ML model, the approximating distribution and the target distribution, wherein the comparing comprises determining whether the approximating distribution is within a predetermined factor of the target distribution. The functions may also include providing, by the primary ML model and based on the comparing, an iteration of the output token string.

In a third example embodiment, a computing device may include a processor and a non-transitory computer-readable medium having stored thereon instructions that, when executed by the processor, cause the processor to perform operations in accordance with the first example embodiment and/or the second example embodiment.

In a fourth example embodiment, an article of manufacture may include a processor and a non-transitory computer-readable medium having stored thereon instructions that, when executed by the processor, cause the processor to perform operations in accordance with the first example embodiment and/or the second example embodiment.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates example output tokens, in accordance with example embodiments.

FIG. 2 illustrates an example method, in accordance with example embodiments.

FIG. 3 illustrates a table, in accordance with example embodiments.

FIG. 4 illustrates a graph, in accordance with example embodiments.

FIG. 5 illustrates a table, in accordance with example embodiments.

FIG. 6 illustrates a graph, in accordance with example embodiments.

FIG. 7 illustrates a table, in accordance with example embodiments.

FIG. 8 illustrates a graph, in accordance with example embodiments.

FIG. 9 illustrates a simple trace diagram, in accordance with example embodiments.

FIG. 10 illustrates a table, in accordance with example embodiments.

FIG. 11 illustrates a training phase and an inference phase of a machine learning model, in accordance with example embodiments.

FIG. 12 is a block diagram of an example computing device 1300, in accordance with example embodiments.

FIG. 13 depicts a distributed computing architecture, in accordance with example embodiments.

FIG. 14 depicts a network of computing clusters arranged as a cloud-based server system, in accordance with an example embodiment

FIG. 15 is an example flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### Overview

In text and/or image domains, larger autoregressive models, such as transformers, may produce higher quality results than smaller models. However, a decode step in a large model may be significantly slower than a decode step in a smaller counterpart model. Also, for example, the decode steps are generally performed serially (e.g., decoding K tokens may involve K serial runs of the model), resulting in a further reduction of computational speed.

Some approaches are directed to increasing an efficiency of inference from large models. Such approaches include distillation, specification, quantization, and/or architecture modification. Some adaptive computation methods may be used that adapt an amount of computation to a degree of difficulty of performing a task. Such approaches include attending to a subset of the inputs, and/or early exits. These approaches generally involve learning, either within the model itself or with an auxiliary model, when a computation shortcut may be leveraged. Although such approaches may result in savings on inference time and arithmetic operations, they may involve a modified architecture, a change of training procedure, training of custom models, and/or re-training of existing models. Also, for example, such approaches may result in a change in the outputs of the model. While some of these approaches may improve a memory to arithmetic-operations ratio, in cases where the ratio remains high, these adaptive computation methods may be used in conjunction with the speculative sampling methods described herein.

Another approach involves Shallow Aggressive Decoding (SAD) that involves decoding multiple tokens in parallel. SAD is not based on a smaller approximation model, and instead copies an input to an output. This limits the applicability to situations where the inputs and outputs are similar, such as, for example, grammatical error correction. Additionally, SAD does not support a general stochastic sampling setting. Yet another approach, Wisdom of Committees (WoC), leverages off-the-shelf smaller models. However, WoC is an adaptive computation approach and not a speculative execution approach, and uses a heuristic to determine when to stop. This can result in outputs that may no longer be within a predetermined factor of outputs of the larger models.

Large autoregressive models, and in particular, large transformers, play a significant role in performing several complex tasks. Accordingly, several approaches have been developed to increase the speed of inference of these models. Some approaches aim to reduce an inference cost for all inputs equally. Other approaches are based on an observation that not all inference steps may be alike. For example, some steps may involve very large models, while some other steps may be approximated well by more efficient models. Such adaptive computation methods attempt to use fewer compute resources for easier inference steps. While some of these methods can be effective in practice, they are generally based on modifying the model architecture, changing the training-procedure and/or re-training the models, and may not maintain outputs that are identical to the larger models.

Inference from larger models may not, in general, be bottlenecked on arithmetic operations. Instead, memory bandwidth and communication may be impacted, and additional computation resources may be available. Accordingly, increasing concurrency may be used as a complementary approach to using an adaptive amount of computation. In particular, as described herein, speculative execution may result in accelerating the inference process without a change in model architecture, a change to training procedures, without re-training the models, and without a change to a probability distribution of the model output.

Speculative execution is an optimization technique, generally applied to processors, where a task may be performed in parallel to verify whether an output meets target specifications. The payoff can be an increase in concurrency. Branch prediction is an example of speculative execution. For speculative execution to be effective, an efficient mechanism may be configured to suggest tasks to execute that are likely to be desired outputs. As described herein, speculative execution may be configured to be applicable to a stochastic setting, where a desired output of a task maintains certain probabilistic parameters. By applying speculative execution to decoding from models (e.g., autoregressive models such as transformers), generations from smaller approximation models may be sampled as speculative prefixes for the larger models. Accordingly, such speculative sampling can optimize a probability of the speculative subtasks to be accepted, while maintaining a probability distribution of the outputs from the smaller models to be within a predetermined factor of the outputs from the larger models.

In some embodiments, the primary ML model may include a first number of model parameters, and the approximating ML model may include a second number of model parameters. The first number may be greater than the second number. The techniques described herein may be evaluated in a variety of tasks and model sizes, such as unconditional generation from a 97 million parameter GPT-like model trained on 1m1b, English to German translation, news article summarization with an 11 billion parameters T5-XXL model, and a dialog task with a 137 billion parameter LaMDA model. In some embodiments, a model may be implemented for a T5-XXL, and actual walltimes may be compared to those of a robust T5X implementation. In some embodiments, a double to triple out-of-the-box latency improvement may be achieved, without changing a probability distribution of the outputs.

The techniques described herein may be applied in real-world production settings, may not depend on a training of new models, and can maintain outputs similar to those from larger models. Accordingly, in situations where memory bandwidth results in bottleneck, and where additional compute resources are available, the techniques described may accelerate sampling from autoregressive models like transformers.

Speculative execution is an approach applied in the context of processors. Speculative sampling, as described herein, is an application of speculative execution to the stochastic context. Speculative sampling may be used with a decoding mechanism that can accelerate decoding from autoregressive models, without a change to model architectures, training regimes, and/or output probability distributions.

### Standardized Sampling

Generally, several methods and parameters of sampling may be used, such as argmax, top-k, nucleus, and setting a temperature. Such sampling methods are usually applied differently at a logits level. However, these sampling methods may be viewed as standard sampling based on an adjusted probability distribution. For example, argmax sampling may be equivalent to zeroing out non-max elements of the distribution and normalizing.

Accordingly, standard sampling may be used to describe the techniques, while other sampling methods may be viewed as equivalent to standard sampling with an appropriate distribution. As used herein, the letter “p” may generally refer to primary (e.g., Mₚ may refer to a primary or larger model, and p(x) may denote a distributions from Mₚ), and the letter “q” may generally refer to an approximation (e.g., M_{q} may refer to an approximation or smaller model, and q(x) may denote a distribution from M_{q}).

Some embodiments involve receiving, by a primary machine learning (ML) model, an input prompt corresponding to a task, wherein the primary ML model is trained to iteratively generate an output token string in response to the input prompt. The task may be any task where a model receives a prompt and generates an output comprising a plurality of tokens. In some embodiments, the task may be one or more of a language modeling task, a text generation task, or a multimodal sequence generation task. In some embodiments, the language modeling task may be a translation task involving translating an input phrase from a first language to a second language. In some embodiments, the task may be a summarization task or a dialog task. Generally, any task informed by an autoregressive token may be performed. For example, a text generation task (e.g., summarization, question-answering, etc.), or a multimodal sequence generation task (e.g. image generation, audio generation, etc.).

### Speculative Sampling

Some embodiments involve providing, by the primary ML model and based on the comparing, an iteration of an iteratively output token string.

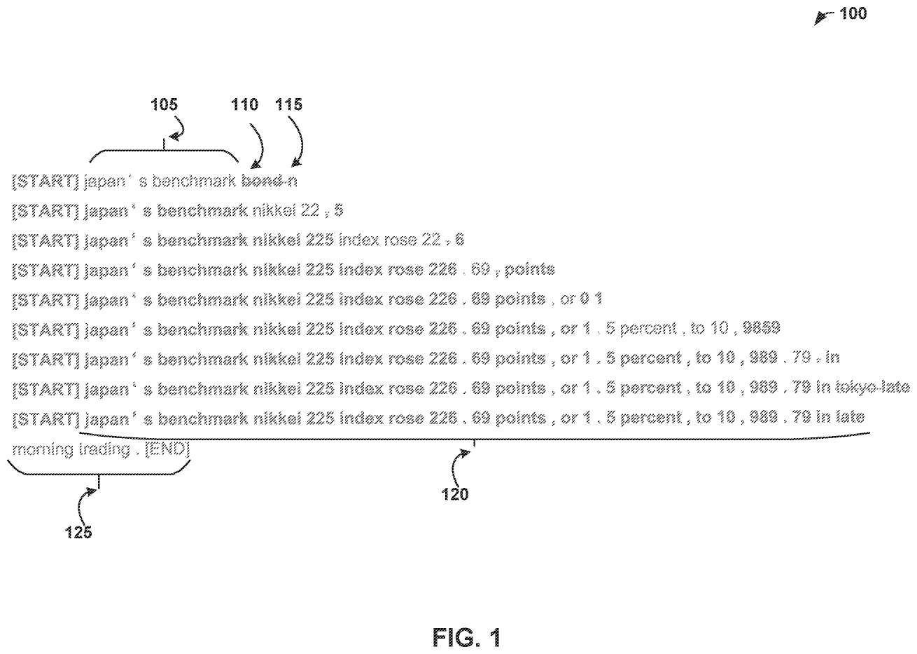

FIG. 1 illustrates example output tokens 100, in accordance with example embodiments. For example, the technique may be illustrated in the context of unconditional language modeling. Each line represents one iteration of the algorithm. In this example, the approximation model may be, for example, a GPT-like Transformer decoder with six (6) million (M) parameters trained on a benchmark corpus used for measuring progress in statistical language modeling (e.g., 1m1b dataset with 8 k tokens). In some embodiments, the large or primary model may be, for example, a GPT-like transformer decoder with 97 M parameters in the same setting as the approximation model. As indicated in the first line, first tokens 105 are suggestions made by the approximation model that are accepted by the primary model, second token 110 is a rejected token, and third token 115 is a corrected token substituted for a rejected token. For example, in the first line the large model may be run once, and five tokens may be generated.

Generally speaking, any approximation model may be used, and the model may not have to be configured to approximate the primary model (e.g., the approximation model may be a generic off-the-shelf model). However, higher speeds may be expected the closer the approximation model is to the primary model. Accordingly, the techniques described herein may be performed by an approximation model configured to approximate the primary ML model, as well as a generic off-the-shelf model.

The last line illustrates a plurality of output tokens 120, and accepted tokens 125 indicating tokens output by the approximation model and accepted by the large or primary model. For example, the output sentence in the last line of FIG. 1, includes 38 tokens, and may be generated by nine (9) serial runs of a larger primary model (e.g., with 97 million parameters) and the approximations may be provided by a smaller approximation model (e.g., with 6 million parameters), while the probability of generating the tokens remains the same for both the larger and smaller models.

Some embodiments involve receiving, by the primary ML model and from an approximating ML model, a candidate token to be evaluated for appending to an initial prefix of an iteratively output token string, wherein the candidate token is determined by the approximating ML model by sampling from an approximating distribution, and wherein the approximating distribution is conditioned on the initial prefix. The term “candidate token” as used herein may generally refer to a guess output by a smaller approximating model.

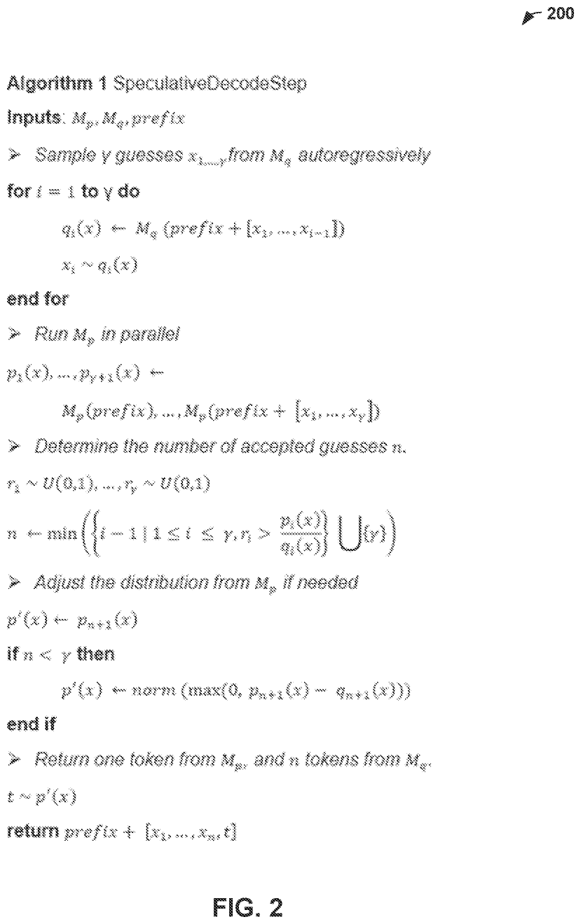

FIG. 2 illustrates an example method 200, in accordance with example embodiments. For example, to sample x with a probability p(x), x~p(x), x may instead be sampled with a probability q(x), x~q(x). Some embodiments involve comparing, by the primary ML model, the approximating distribution and the target distribution, wherein the comparing involves determining whether the approximating distribution is within a predetermined factor of the target distribution. Some embodiments involve accepting, by the primary ML model and based on a determination that the approximating distribution is within the predetermined factor of the target distribution, the candidate token as the next token. The providing of the iteration of an iteratively output token string involves providing the initial prefix appended with the next token. In some embodiments, the comparing involves determining that the approximating distribution is smaller than the target distribution or identical to the target distribution. Such embodiments involve accepting, by the primary ML model and based on a determination that the approximating distribution is within a predetermined factor of the target distribution or identical to the target distribution, the candidate token as the next token to be appended to the initial prefix. For example, the sampled value x may be accepted by the primary model Mₚ, if q(x)≤lp(x), where l is a predetermined factor. In some embodiments, l may be 1, 5, 10, and so forth. This is described in more detail below and in the context of lenience.

Some embodiments involve rejecting, by the primary ML model and based on a determination that the approximating distribution is not within the predetermined factor of the target distribution, the candidate token as the next token. In some embodiments, the comparing involves determining that the approximating distribution is greater than the target distribution. Such embodiments involve rejecting the candidate token as the next token. Such embodiments involve determining an additional distribution based on a difference between the approximating distribution and the target distribution. Such embodiments involve sampling, based on the additional distribution, another candidate token to be evaluated for appending to the initial prefix. Such embodiments involve accepting or rejecting the other candidate token as the next token based on the additional distribution. For example, in the event q(x)>l p(x), then the sampled value x may be rejected by the primary model Mₚ with a probability:

$$1 - \frac{lp ( x )}{q ( x )} \qquad ( Eqn . 1 )$$

where l denotes the predetermined factor. Some embodiments involve receiving, by the primary ML model and from the approximating ML model, another candidate token to be evaluated for appending to the initial prefix, wherein the other candidate token is determined by the approximating ML model by sampling from an adjusted approximating distribution, wherein the adjusted approximating distribution is based on a difference between the approximating distribution and the target distribution. Such embodiments involve speculatively determining, by the primary ML model and based on the other candidate token appended to the initial prefix, a modified target distribution. Such embodiments involve comparing, by the primary ML model, the adjusted approximating distribution and the modified target distribution, wherein the comparing comprises determining whether the adjusted approximating distribution is within the predetermined factor of the modified target distribution. Such embodiments involve accepting, by the primary ML model and based on a determination that the adjusted approximating distribution is within the predetermined factor of the target distribution, the other candidate token as the next token. For example, for l=1, another value (also denoted as x) may be sampled from an adjusted distribution p′(x)=norm (max(0,p(x)−q(x))). Generally, for distributions p(x) and q(x), when x is sampled using the aforementioned process, the distributions of sampling x from an approximation model and from a primary model are the same.

In some embodiments, the tokens output by method 200 may be distributed in a manner identical to those outputted by Mₚ. In particular, a token x output by the algorithm may be shown to satisfy x~p(x). Generally, p′(x) satisfies:

$${p}^{′} ( x ) = \frac{max ( 0 , p ( x ) - q ( x ) )}{1 - α} = \frac{p ( x ) - min ( q ( x ) , p ( x ) )}{1 - α} \qquad ( Eqn . 2 )$$

However,

P(x=x′)=P(guess accepted,x=x′)+P(guess rejected,x=x′) (Eqn. 3)
where

$$P ( guess accepted , x = {x}^{′} ) = q ( {x}^{′} ) min ( 1 , \frac{p ( {x}^{′} )}{q ( {x}^{′} )} ) = min ( q ( {x}^{′} ) , p ( {x}^{′} ) ) \qquad ( Eqn . 4 )$$

$$and$$

$$P ( guess rejected , x = {x}^{′} ) = ( 1 - α ) {p}^{′} ( {x}^{′} ) = p ( {x}^{′} ) - min ( q ( {x}^{′} ) , p ( {x}^{′} ) ) \qquad ( Eqn . 5 )$$

Overall,

P(x=x′)=min(p(x′),q(x′))+p(x′)−min(p(x′),q(x′))=p(x′) (Eqn. 6)

Some embodiments involve speculatively determining, by the primary ML model and based on the candidate token appended to the initial prefix, a target distribution for a next token to be appended to the initial prefix. For example, given the distribution q(x) obtained from running M_{q} on a conditioning or initial prefix, prefix, a token x₁ may be sampled from distribution q(x), x₁~q(x). The distribution p(x) may be determined by running Mₚ on prefix, while in parallel, speculatively determining a distribution of the next token x₂ by running Mₚ on prefix+[x₁]. Upon a completion of these computations, the algorithm may be applied as before. For example, in the event that x₁ is rejected, then x₂ may be rejected (or not accepted). Also, x₁ may be re-sampled from an adjusted distribution, and in the event that x₁ is accepted, both tokens x₁ and x₂ may be accepted.

Some embodiments involve receiving, by the primary ML model and from the approximating ML model, a second candidate token, wherein the second candidate token is sampled from a second approximating distribution, and wherein the second approximating distribution is conditioned on the initial prefix appended with the candidate token. Such embodiments involve speculatively determining, by the primary ML model and based on the initial prefix appended with the candidate token and the second candidate token, a second target distribution for another next token for another iteration of the iteratively output token. Such embodiments involve performing, by the primary ML model, a second comparing of the second approximating distribution and the second target distribution, wherein the second comparing comprises determining whether the second approximating distribution is within the predetermined factor of the second target distribution. The providing of the iteration of the iteratively output token string involves providing, based on the second comparing, the other iteration of the iteratively output token.

Some embodiments involve receiving, by the primary ML model and from the approximating ML model, a plurality of additional candidate tokens sampled from a respective plurality of additional approximating distributions. Such embodiments involve speculatively determining, in parallel and by the primary ML model, a respective plurality of additional target distributions based on appending to the initial prefix, one or more additional candidate tokens selected at random from the plurality of additional candidate tokens. Such embodiments involve performing, in parallel and by the primary ML model, additional comparisons of the plurality of additional approximating distributions and the respective plurality of additional target distributions. Such embodiments involve providing, by the primary ML model and based on the additional comparisons, another iteration of the iteratively output token string.

For example, the aforementioned process may be applied to sample between 1 and γ+1 tokens concurrently. For example, method 200 may involve receiving inputs Mₚ, M_{q}, and prefix. Then, method 200 may involve sampling γ guesses x₁, . . . , x_{γ} from M_{q}, such as for example, in an autoregressive manner. In some embodiments, method 200 may involve running Mₚ in parallel. Then, method 200 may involve determining a number of accepted guesses n. Some embodiments may involve adjusting a distribution from Mₚ. Then, method 200 may involve returning one token from Mₚ, and n tokens from M_{q}.

Generally speaking, there are differences between speculative sampling and rejection sampling. For example, rejection sampling may also involve an iterative sampling procedure such as: (i) sample x~q(x) and r~U(0,1), wherein U(0,1) represent a uniform distribution, (ii) return x if

$$r < \frac{p ( x )}{M q ( x )}$$

where

$$M = {max}_{x} \frac{p ( x )}{q ( x )} ,$$

(iii) go to (i), In some embodiments, a non-iterative version of rejection sampling may be used. For example, steps (i) and (ii) may be performed, and sampling may be based on an unmodified p(x) directly. Such an approach is generally less efficient than a process based on speculative sampling, as described herein. For example, the acceptance probability based on a non-iterative version of rejection sampling may be:

$${E}_{x \sim q ( x )} \frac{p ( x )}{Mq ( x )} = {\sum }_{x} p ( x ) {min}_{{x}^{′}} \frac{q ( {x}^{′} )}{p ( {x}^{′} )} \leq {\sum }_{x} p ( x ) min ( 1 , \frac{q ( x )}{p ( x )} ) = {\sum }_{x} min ( p ( x ) , q ( x ) ) = α \qquad ( Eqn . 7 )$$

Such an acceptance probability may be lower than an acceptance probability based on speculative sampling.

### Lenience

Also, for example, method 200 may involve maintaining an output distribution from an approximation model that is substantially the same as an output distribution from a primary model. In some embodiments, an additional inference speed improvement may be achieved by modifying the method described herein. For example, when two models are trained with identical architectures and sizes, and on the same training dataset, the generated probability distributions may not be identical. In other words, some leniency may be allowed in terms of comparing the two distributions, and the distributions may not be identical. For purposes of illustration, results described herein may be based on identical output distributions, without an allowance for lenience.

In the event lenience is enabled for a model, a lenience parameter (also referred to herein as a predetermined factor) l∈[0,1] may be applied, and the distribution q(x) may be multiplied by l prior to a comparison with p(x). Such an adjusted distribution maintains a property that a token may not be sampled with probability greater than

$$\frac{p ( x )}{l} .$$

For example, with

$$l = \frac{1}{10} ,$$

a token may not be sampled with more than ten times a ground truth probability. Accordingly, tokens that have a low probability of occurrence (e.g., very rare tokens) continue to have a low probability of occurrence with the adjusted distribution q(x). In some embodiments, with a lenience factor l, an acceptance probability may be based on:

$$α = {E}_{x \sim q ( x )} \{ \begin{matrix}1 , & lq ( x ) \leq p ( x ) \\ \frac{p ( x )}{lq ( x )} , & lq ( x ) > p ( x )\end{matrix} = = {E}_{x \sim q ( x )} \frac{p ( x )}{max ( p ( x ) , l q ( x ) )} = {\sum }_{x} \frac{p ( x ) q ( x )}{max ( p ( x ) , l q ( x ) )} = \frac{1}{l} {\sum }_{x} min ( p ( x ) , lq ( x ) ) = {\sum }_{x} min ( \frac{p ( x )}{l} , q ( x ) ) \qquad ( Eqn . 8 )$$

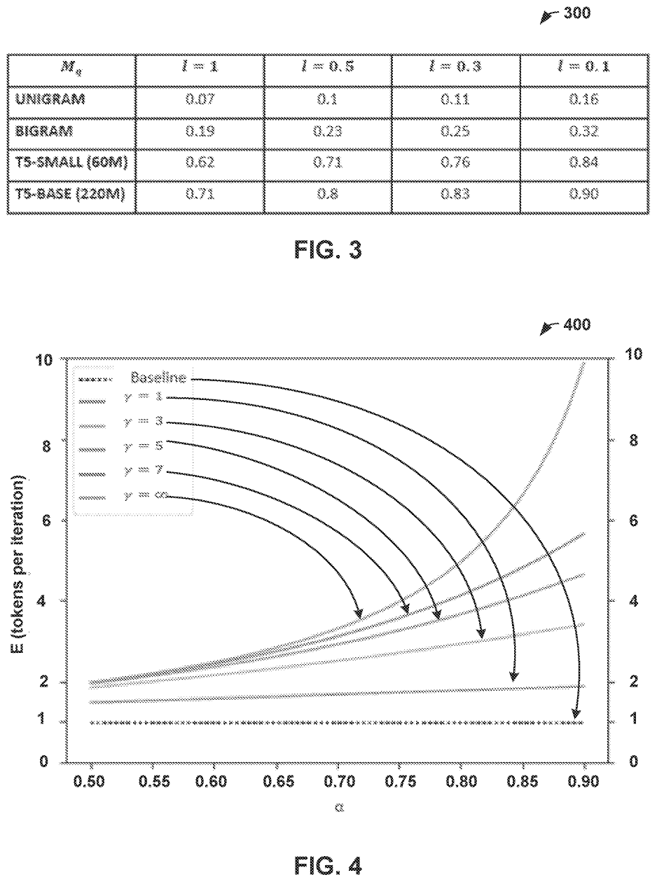

FIG. 3 illustrates a table 300, in accordance with example embodiments. FIG. 4 shows values of an acceptance probability, a, for different values of l. In some embodiments, Mₚ may be a T5-XXL (e.g., with 11 billion parameters) and Mg may be a T5-small (e.g., with 60 million parameters). With a value of c=0.015, and for lenience values of 1, 0.5, 0.3, and 0.1 (meaning that no token can be sampled with probability greater than one, two, three, or ten times the ground truth), improvement factors of 2.5×, 3.1×, 3.6×, and 5× respectively may be achieved.

### Number of Generated Tokens

A reduction factor in a number of serial calls to the large model may be analyzed. For example, an expected number of tokens produced by a single run of method 200 may be analyzed.

The acceptance rate β_{x<t}, for a given prefix x_{<t}, with a probability of accepting xₜ~q(x^{y}|x_{<t}) may be analyzed. The term E(β) may represent a natural measure of how well M_{q} approximates Mₚ. In some embodiments, the terms β may be considered to be independent and identically distributed, and α=E(β) may be allowed. As a result, a number of tokens produced by a single run of method 200 may be a capped geometric variable, with p=1−a and cap=γ+1, and an expected number of tokens generated by method 200 may satisfy an expected token generation relationship as follows:

$$E ( \# generated tokens ) = \frac{1 - {α}^{γ + 1}}{1 - α} \qquad ( Eqn . 9 )$$

FIG. 4 illustrates a graph 400, in accordance with example embodiments. For example, FIG. 4 illustrates a graph 400 that illustrates a comparison of an expected number of tokens generated by method 200 as a function of a for various values of γ (e.g., γ=1, 3, 5, 7, ∞).

### Determining an Acceptance Probability

In some embodiments, an acceptance probability a may be determined for a given prefix and the two models Mₚ and M_{q}. A natural divergence D_{LK} may be determined:

$${D}_{LK} ( p , q ) = {\sum }_{x} \vert p ( x ) - M ( x ) \vert = {\sum }_{x} \vert q ( x ) - M ( x ) \vert \qquad ( Eqn . 10 )$$

where

$$M ( x ) = \frac{p ( x ) - q ( x )}{2} .$$

Also, a relationship such as D_{LK} (p,q)=1−Σₓ min(p(x),q(x)) may be determined as follows:

$${D}_{LK} ( p , q ) = {\sum }_{x} \vert p ( x ) - M ( x ) \vert = {\sum }_{x} \frac{\vert p - q \vert}{2} = 1 - {\sum }_{x} \frac{p + q - \vert p - q \vert}{2} = 1 - {\sum }_{x} min ( p ( x ) , q ( x ) ) \qquad ( Eqn . 11 )$$

Accordingly, the natural divergence D_{LK}(p,q) may be determined to be a symmetric divergence in the interval [0,1]. For example, D_{LK}(p,q)=0⇔p=q, where “⇔” represents logical equivalence. Accordingly, D_{LK}(p,q)=1⇔p and q have disjoint support.

In some embodiments, a relationship β=1−D_{LK}(p,q) may be determined as follows:

$$β = {E}_{x ∼ q ( x )} \{ \begin{matrix}1 , & q ( x ) \leq p ( x ) \\ \frac{p ( x )}{q ( x )} , & q ( x ) > p ( x )\end{matrix} = {E}_{x ∼ q ( x )} min ( 1 , \frac{p ( x )}{q ( x )} ) = {\sum }_{x} min ( p ( x ) , q ( x ) ) \qquad ( Eqn . 12 )$$

Accordingly, the acceptance probability may be determined as a corollary to be:

α=1−E(D_{LK}(p,q)) (Eqn. 13)

In some experimental situations, with various different tasks, sampling methods, and off-the-shelf models (e.g., where Mg is around two orders of magnitude smaller than Mₚ), empirical a values in the range 0.5 to 0.9 may be obtained.

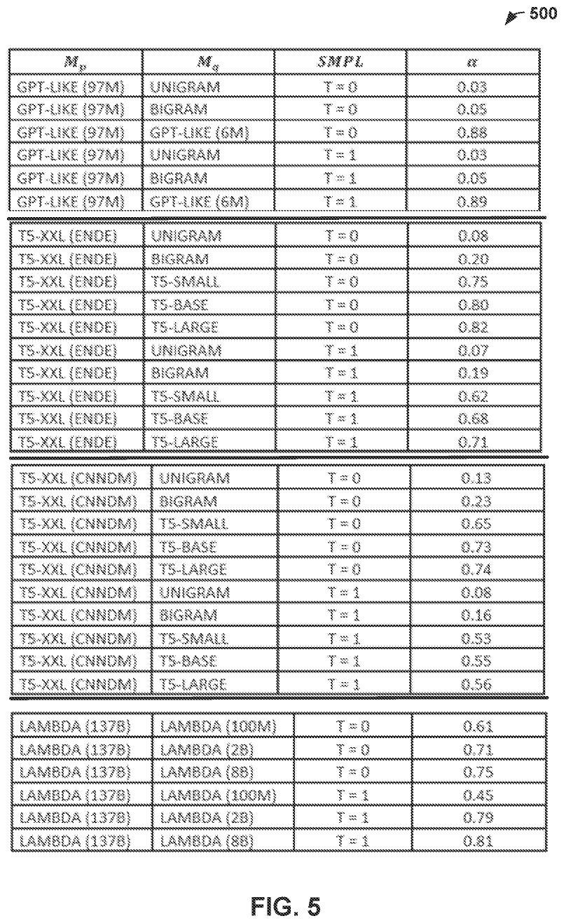

FIG. 5 illustrates a table 500, in accordance with example embodiments. For example, table 500 illustrates empirical a values for various models Mₚ, approximation models M_{q}, and sampling settings. For example, “T=0” may denote argmax sampling (SMPL), and “T=1” may denote standard sampling. As illustrated, outputs from a LaMDA model may be passed through a Top₄₀ filter. However, this generally does not impact the argmax, but may have an impact on standard sampling.

### Walltime Improvement

As described with respect to Eqn. 9, an assumption that the terms β are independent and identically distributed, may result in a reduction of a number of calls to the primary model by a factor, such as, for example, a factor of

$$\frac{1 - {α}^{γ + 1}}{1 - α} .$$

Increased concurrency may be generally supported with sufficient compute resources. For a walltime analysis, in some embodiments, γ+1 concurrent evaluations of Mₚ may be run in parallel without increasing the walltime. To determine an aggregate walltime improvement, a cost of running the small model M_{q} may be determined. For example, a cost coefficient, c, may represent a ratio between a first time for a single run of Mg and a second time for a single run of Mₚ.

Although the acceptance probability a may be an intrinsic property of the models and/or the task, the value of c may be dependent on parameters such as a hardware configuration, software implementation details, and so forth. In some embodiments, M_{q} may be a few (e.g., 2) orders of magnitude smaller than Mₚ, and in such embodiments, c may be maintained to be less than 0.05, and may be negligibly close to 0.

Generally speaking, the expected improvement factor in total walltime by method 200 may be determined to be

$$\frac{1 - {α}^{γ + 1}}{( 1 - α ) ( γ c + 1 )} \qquad ( Eqn . 14 )$$

For example, the cost of running a single step of Mₚ may be denoted by T. Each run of method 200 may incur a cost Tcγ+T (e.g., for running the approximation model Mg Y times and running Mₚ once). Accordingly, the expected token generation relationship in Eqn. 9 indicates that

$$\frac{1 - {α}^{γ + 1}}{1 - α}$$

tokens may be generated on average. In some embodiments, an aggregate expected cost for producing a token may be determined to be

$$\frac{( c γ + 1 ) ( 1 - α )}{1 - {α}^{γ + 1}} T \qquad ( Eqn . 15 )$$

Also, for example, a cost of producing a single token with the standard decoding algorithm may be T, and the desired overall expected latency improvement factor may be inferred. In some embodiments, Mₚ may be run at least once, and so long enough generations may be assumed. For example, the improvement factor may be capped by a number of generated tokens.

In some embodiments, when α>c, then it may be shown that an optimal number of γ may be determined to obtain an improvement, and the improvement factor may be at least

$$\frac{1 + α}{1 + c} .$$

For example, if an improvement corresponding to γ may likely result in an improvement for γ* that satisfies 0<γ*<γ. Accordingly, an improvement may be obtained by using γ=1 in Eqn. 14, and that may result in

$$\frac{1 - {α}^{2}}{( 1 - α ) ( c + 1 )} = \frac{1 + α}{1 + c} \qquad ( Eqn . 16 )$$

### Number of Arithmetic Operations

As illustrated, method 200 may involve γ+1 runs of Mₚ in parallel. Accordingly, a number of concurrent arithmetic operations may grow by a factor of γ+1. However, method 200 may generate at most γ+1 tokens per run. Accordingly, a total number of arithmetic operations may be higher than that of a standard decoding algorithm. For example, when a candidate token from Mg is accepted, the increased concurrency may be “free” and the total number of operations may not be increased. Also, for example, when a candidate token from M_{q} is rejected, a computation may be considered to have been a wasted resource. An effect of the described method on a total number of arithmetic operations may be analyzed.

For example, ¿ may represent a ratio of arithmetic operations per token of the primary model to that of the approximation model. The factor of increase in number of operations may be obtained by substituting c=1+ĉ in Eqn. 14 (if ĉ is negligibly small, then a substitution such as c=1 may be appropriate). If α is low, an increase in the number of arithmetic operations may be high, and vice-versa. In general, for transformer decoders, the total number of arithmetic operations performed by method 200 (not counting runs of M_{q}) may be bounded from above by a single run of the same-size transformer encoder.

In some embodiments, a total memory bandwidth may decrease. For example, weights and caches associated with the large model may be read once per execution of method 200. Accordingly, the memory bandwidth for reading them may decrease by a factor of

$$\frac{1 - {α}^{γ + 1}}{1 - α} ,$$

according to Eqn. 9.

### Selection of γ

Given c and a and assuming sufficient compute resources, an optimal γ may be selected to maximize the expected improvement factor determined by Eqn. 14.

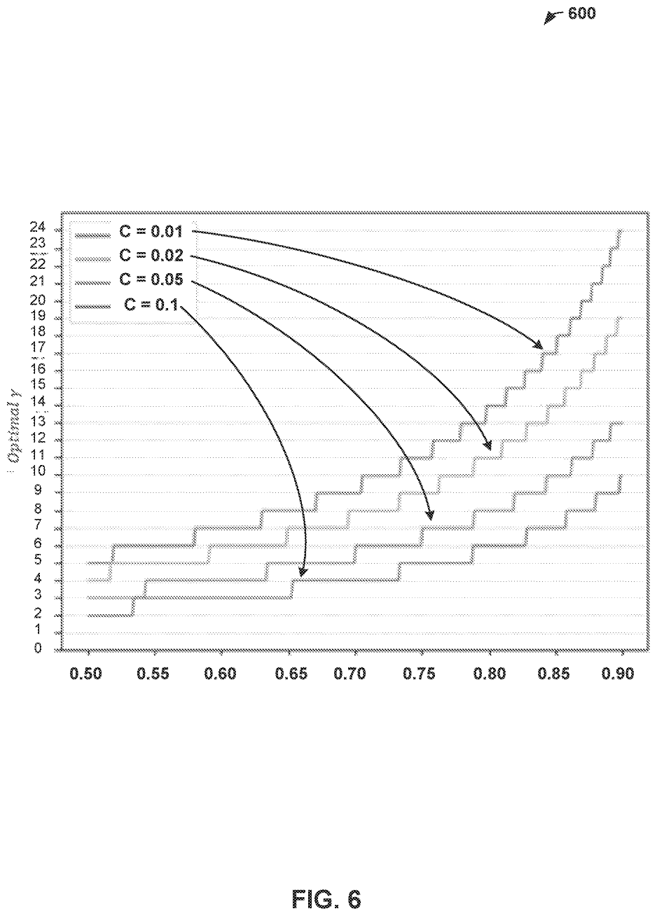

FIG. 6 illustrates a graph 600, in accordance with example embodiments. For example, graph 600 illustrates an optimal value of γ as a function of a for various values of c. Graph 600 illustrates that, since γ is an integer, it may be determined numerically. Depending on an amount of available compute resources, an appropriate choice for γ may include values that are lower than the optimal value, which corresponds to an unbounded computational power.

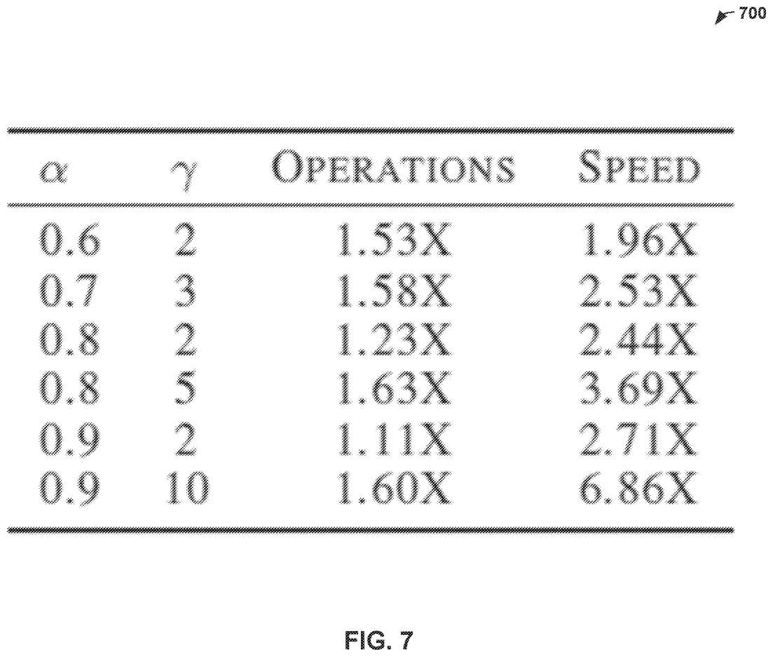

FIG. 7 illustrates a table 700, in accordance with example embodiments. For example, table 700 illustrates a total number of arithmetic operations and an inference speed as compared to a baseline, for various values of γ and α, and an assumption that c=ĉ=0.

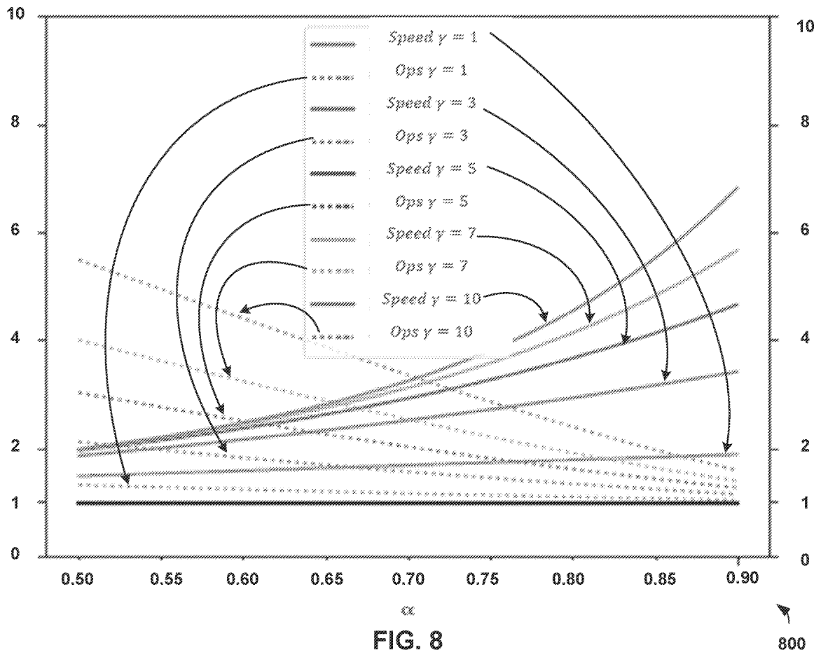

FIG. 8 illustrates a graph 800, in accordance with example embodiments. For example, graph 800 illustrates an improvement in speed and an increase in a number of operations as a function of α for various values of γ.

Together, FIGS. 7 and 8 illustrate a trade-off between inference speed and total number of arithmetic operations for various values of α and γ, and an assumption that c=ĉ=0.

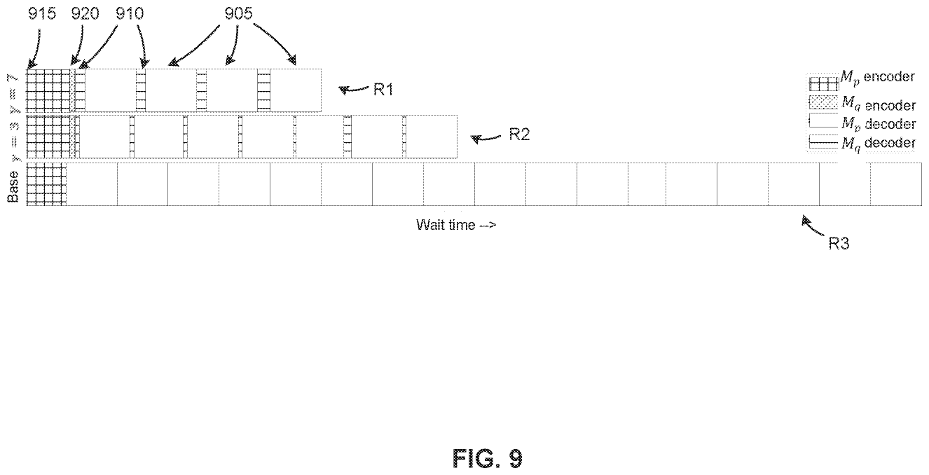

FIG. 9 illustrates a simple trace diagram, in accordance with example embodiments. More specifically, FIG. 9 illustrates a simplified trace diagram for a full encoder-decoder transformer stack. With sufficient computational power, calls to Mₚ may take approximately the same time. The top row R1 illustrates decoding based on method 200 with γ=7. Accordingly, each of the calls to Mₚ, as represented by first blocks 905) is preceded by 7 calls to M_{q} (represented by second blocks 910). The third block 915 on the left represents a call to the encoder for Mₚ, and the fourth block 920 represents a call to the encoder for M_{q}. Likewise, the middle row R2 illustrates method 200 with γ=3, and the bottom row R3 illustrates standard decoding.

In some embodiments, instead of selecting one value for γ based on α, since the βs are not constant, a further improvement may be achieved by predicting the value of β and varying the value of γ accordingly for each run of method 200. To obtain an upper bound on the additional improvement factor, we may assume a predictor for γ. Accordingly,

$$E ( \# generated tokens ) = \frac{1}{1 - α} .$$

For typical values of c and a, and assuming unbounded compute resources, the enhanced walltime improvement factor may be up to approximately 60% higher than an improvement factor with a fixed γ.

### Example Approximation Models

In some embodiments, approximation models may correspond to c≈0. For example, approximation models may be associated with a negligible cost relative to the primary model. Some embodiments may involve n-gram models. In such situations, an improvement of

$$\frac{1 - {α}^{γ + 1}}{1 - α}$$

may be obtained, and this expression may be bounded from above by

$$\frac{1}{1 - α} ,$$

and may be equal if γ is large. As shown in FIG. 5, such situations may result in non-zero values of a. For example, for an English-German translation task, with Mₚ being T5-XXL 11B and M_{q} being a trivial bigram model, a value of a≈0.2 may be achieved, resulting in an inference speed improvement factor of 1.25× with γ=3.

In some embodiments, the one or more of the approximating ML model or the primary ML model may be an autoregressive model. In some embodiments, the autoregressive model may be a transformer model. In some embodiments, the approximating ML model may be a non-autoregressive model. For example, method 200 may be extended to situations where the approximation model Mg is non-autoregressive. For example, instead of the autoregressive loop in method 200 a single call may be made to the non-autoregressive model. In some embodiments, a custom non-autoregressive model may be trained to achieve this. A In some embodiments, the approximation model may be configured to select tokens at random, and this may result in additional improvement for model Mₚ.

### Empirical Walltime Improvement

In some embodiments, an implementation of method 200 may be compared to an implementation in the T5X codebase for accelerating T5-XXL. In some embodiments, a production grade implementation of method 200 may result in additional improvements over the baseline.

### Setup.

A standard encoder-decoder T5 version 1.1 model may be tested on tasks including (1) English (En) to German (De) translation fine-tuned on a Workshop on Statistical Machine Translation (WMT EnDe) dataset, and (2) text summarization fine-tuned on the CNN Daily Mail (CNN/DM) dataset. For both tasks, T5-XXL (e.g., with 11 billion parameters) may be used for Mₚ. For the approximation model M_{q} several existing configurations may be tested, namely T5-large (e.g., with 800 million parameters), T5-base (e.g., with 250 million parameters), and T5-small (e.g., with 77 million parameters). Walltime improvements may be measured with a batch size of 1 on a single TPU-v4 for both argmax sampling (temp=0) and standard sampling (temp=1).

### Results.

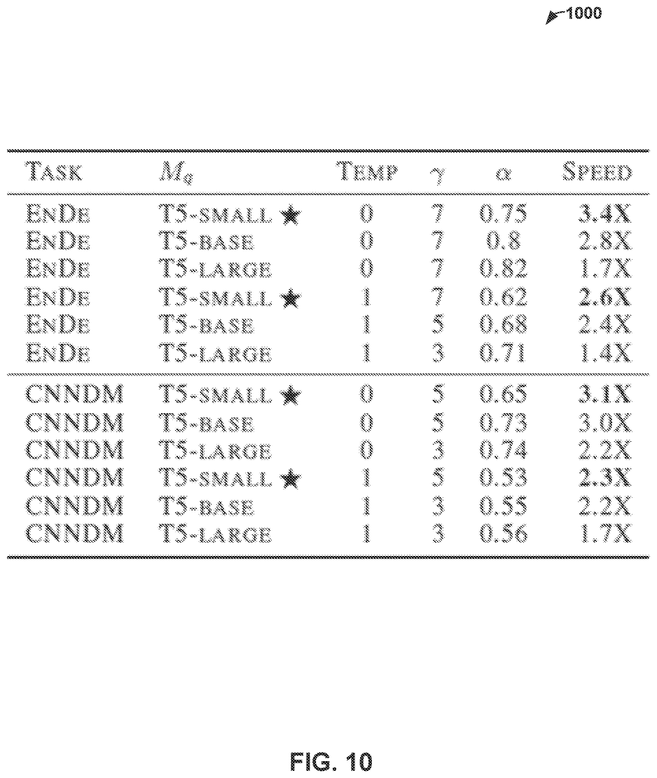

FIG. 10 illustrates a table 1000, in accordance with example embodiments. For example, table 1000 provides empirical results for speeding up inference from a T5-XXL 11B model. Table 1000 shows the empirical results from method 200. For example, T5-small (e.g., with 60 million parameters), and a good balance of c and α, may provide a greater speedup out of the tested approximation models. As expected, α may increase with a size of the approximation model. Also, for example, α and walltime improvement may be higher for argmax sampling (temp=0). In some embodiments, speedups of 2.6× (temp=1) and 3.4× (temp=0) may be obtained on a translation task and slightly lower speedups of 2.3× (temp=1) and 3.1× (temp=0) may be obtained for a summarization task.

### Empirical a Values

Values for a may be determined for various tasks, sampling methods, models Mₚ and corresponding approximation models M_{q}. For example, an expectation may be evaluated based on Eqn. 13 on ten thousand tokens generated by Mₚ, for several parameter settings described below.

GPT-Like (e.g., with 97 Million Parameters)

A decoder-only transformer model may be tested on unconditional language generation, the transformer model having been trained on 1m1b. The model here may be a GPT-like transformer decoder-only with Gelu activations. For Mg, a Transformer decoder-only model with six million parameters may be used, and with dim 256, dim feed-forward 1024, 2 layers, 4 attention heads, and simple unigram and bigram models. Mₚ may have ninety seven million parameters, and with dim 768, dim feed-forward 3072, 12 layers, 12 attention heads. In some embodiments, Bert tokenization with eight thousand tokens may be used for the models.

LaMDA (e.g., with 137 Billion Parameters)

A decoder only Language Model for Dialogue Applications (LaMDA) may be tested on a dialog task. Some existing checkpoints from LaMDA 137B as Mₚ, and LaMDA 8B, LaMDA 2B, and LaMDA 100 M for M_{q}, may be used.

Referring again to FIG. 5, the a values for the tested cases are summarized in table 500. Generally speaking, approximation models that are a couple of orders of magnitude smaller than the large model may produce a values between 0.5 and 0.9. Also, for example, the sharper the adjusted distribution, the higher the a values. As another example, unigram and bigram approximations may yield non-zero a values. For example, for the case of English to German translation, the bigram model may yield an a value of 0.2, and since c=0 in this case, may yield a 1.25× speed improvement.

Let Mₚ denote the primary model, and let p(xₜ|x_{<t}) denote the distribution obtained from the model for a prefix x_{<t}. Let M_{q} denote a smaller and more efficient approximation model for the same task, and let q(xₜ|x_{<t}) denote the distribution obtained from the model for a prefix x_{<t}. For simplicity, p(x) may denote p (xₜ|x_{<t}) whenever the prefix x_{<t} is clear from the context, and similarly for q(x) may denote q(xₜ|x_{<t}). As described herein, one or more objectives of the techniques described herein involve using the more efficient approximation model M_{q} to generate a number of completions, γ∈Z⁺, and subsequently use the primary model Mₚ to evaluate all of the candidate tokens for completion and their respective probabilities from Mg in parallel. Some embodiments involve determining a terminal token based on a terminal token distribution. The providing of the iteration of the iteratively output token string involves appending the terminal token to terminate the output token string. For example, tokens that may lead to an identical distribution may be accepted, and an additional token from an adjusted distribution may be sampled to correct the first token that was rejected, or to add an additional token if all token are accepted. Accordingly, each parallel run of the primary model Mₚ may generate at least one new token. Accordingly, the number of serial runs of the large model may not be larger than the simple autoregressive method, but may potentially generate several new tokens, up to γ+1, depending on how well Mg approximates Mₚ.

As described herein, speculative sampling may enable efficient stochastic speculative execution—i.e. speculative execution in the stochastic setting. An impact of speculative sampling on decoding from autoregressive models like Transformers may be analyzed. In some embodiments, where sufficient compute resources are available, meaningful 2x to 3x speedups may be achieved in practice (e.g., with T5X). This may be achieved by leveraging small off-the-shelf models to approximate the large autoregressive model to accelerate.

Also, for example, in cases where additional arithmetic operations are available (e.g., when memory bandwidth is the bottleneck) the method described herein provides a speedup with significant benefits. For example, the model architecture does not change, retraining may not be needed, and an output distribution may remain identical. Accordingly, in these situations, the method may be used to speedup inference using out-of-the-box models without developing and evaluating custom schemes.

In some embodiments, custom approximation models may be trained, such as models with custom sizes, or models with custom training procedures (e.g., distillation), and so forth. Also, for example, a hierarchical version of the method described herein may be used. For example, the approximation model itself may be accelerated by faster second approximation model. Although, illustrative purposes, the approximation model and number of guesses γ were fixed for inference, varying them during inference may yield additional improvement as described herein. As another example, speculative sampling may apply in the text modality, and in other domains (e.g. images).

Also, for example, stochastic speculative execution and speculative sampling may be helpful outside the scope of autoregressive models. For example, given two slow functions, f(x) and g(y) such that f(x) generates a distribution from which g's input is sampled, the method described herein may be used to run f and g in parallel. Such a setup may be applicable in physics simulations, and/or in reinforcement learning where f is a large model that produces a distribution on actions, and g is a world simulation.

### Training Machine Learning Models for Generating Inferences/Predictions

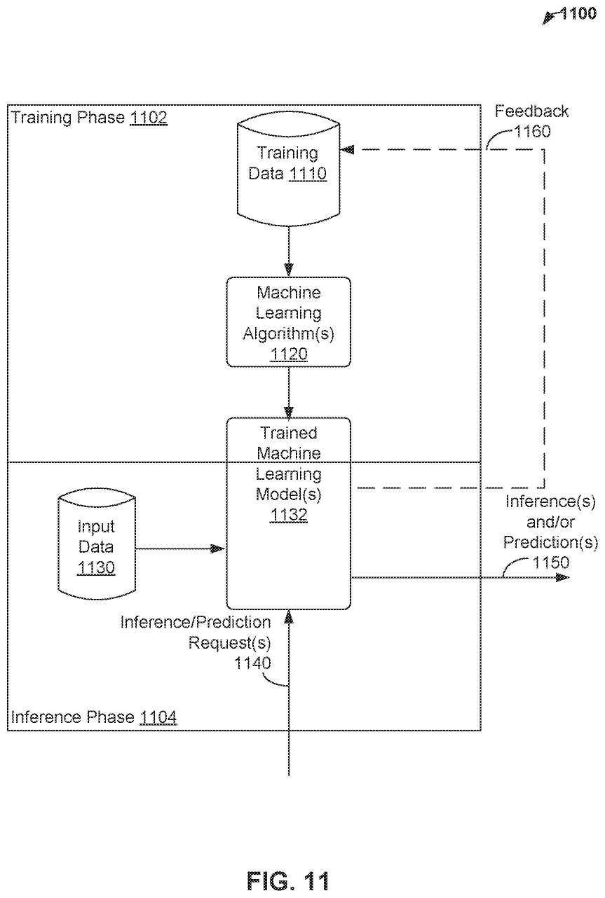

FIG. 11 shows diagram 1100 illustrating a training phase 1102 and an inference phase 1104 of trained machine learning model(s) 1132, in accordance with example embodiments. Some machine learning techniques involve training one or more machine learning algorithms, on an input set of training data to recognize patterns in the training data and provide output inferences and/or predictions about (patterns in the) training data. The resulting trained machine learning algorithm can be termed as a trained machine learning model. For example, FIG. 11 shows training phase 1102 where one or more machine learning algorithms 1120 are being trained on training data 1110 to become trained machine learning model 1132. Then, during inference phase 1104, trained machine learning model 1132 can receive input data 1130 and one or more inference/prediction requests 1140 (perhaps as part of input data 1130) and responsively provide as an output one or more inferences and/or predictions 1150.

As such, trained machine learning model(s) 1132 can include one or more models of one or more machine learning algorithms 1120. Machine learning algorithm(s) 1120 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 1120 may be supervised or unsupervised, and may implement any suitable combination of online and offline learning.

In some examples, machine learning algorithm(s) 1120 and/or trained machine learning model(s) 1132 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 1120 and/or trained machine learning model(s) 1132. In some examples, trained machine learning model(s) 1132 can be trained, reside and execute to provide inferences on a particular computing device, and/or otherwise can make inferences for the particular computing device.

During training phase 1102, machine learning algorithm(s) 1120 can be trained by providing at least training data 1110 as training input using unsupervised, supervised, semi-supervised, and/or weakly supervised learning techniques. Unsupervised learning involves providing a portion (or all) of training data 1110 to machine learning algorithm(s) 1120 and machine learning algorithm(s) 1120 determining one or more output inferences based on the provided portion (or all) of training data 1110. Supervised learning involves providing a portion of training data 1110 to machine learning algorithm(s) 1120, with machine learning algorithm(s) 1120 determining one or more output inferences based on the provided portion of training data 1110, and the output inference(s) are either accepted or corrected based on correct results associated with training data 1110. In some examples, supervised learning of machine learning algorithm(s) 1120 can be governed by a set of rules and/or a set of labels for the training input, and the set of rules and/or set of labels may be used to correct inferences of machine learning algorithm(s) 1120.

Semi-supervised learning involves having correct labels for part, but not all, of training data 1110. During semi-supervised learning, supervised learning is used for a portion of training data 1110 having correct results, and unsupervised learning is used for a portion of training data 1110 not having correct results. In some examples, machine learning algorithm(s) 1120 and/or trained machine learning model(s) 1132 can be trained using other machine learning techniques, including but not limited to, incremental learning and curriculum learning.

In some examples, machine learning algorithm(s) 1120 and/or trained machine learning model(s) 1132 can use transfer learning techniques. For example, transfer learning techniques can involve trained machine learning model(s) 1132 being pre-trained on one set of data and additionally trained using training data 1110. More particularly, machine learning algorithm(s) 1120 can be pre-trained on data from one or more computing devices and a resulting trained machine learning model provided to a particular computing device, where the particular computing device is intended to execute the trained machine learning model during inference phase 1104. Then, during training phase 1102, the pre-trained machine learning model can be additionally trained using training data 1110, where training data 1110 can be derived from kernel and non-kernel data of the particular computing device. This further training of the machine learning algorithm(s) 1120 and/or the pre-trained machine learning model using training data 1110 of the particular computing device's data can be performed using either supervised or unsupervised learning. Once machine learning algorithm(s) 1120 and/or the pre-trained machine learning model has been trained on at least training data 1110, training phase 1102 can be completed. The trained resulting machine learning model can be utilized as at least one of trained machine learning model(s) 1132.

In particular, once training phase 1102 has been completed, trained machine learning model(s) 1132 can be provided to a computing device, if not already on the computing device. Inference phase 1104 can begin after trained machine learning model(s) 1132 are provided to the particular computing device.

During inference phase 1104, trained machine learning model(s) 1132 can receive input data 1130 and generate and output one or more corresponding inferences and/or predictions 1150 about input data 1130. As such, input data 1130 can be used as an input to trained machine learning model(s) 1132 for providing corresponding inference(s) and/or prediction(s) 1150 to kernel components and non-kernel components. For example, trained machine learning model(s) 1132 can generate inference(s) and/or prediction(s) 1150 in response to one or more inference/prediction requests 1140. In some examples, trained machine learning model(s) 1132 can be executed by a portion of other software. For example, trained machine learning model(s) 1132 can be executed by an inference or prediction daemon to be readily available to provide inferences and/or predictions upon request. Input data 1130 can include data from the particular computing device executing trained machine learning model(s) 1132 and/or input data from one or more computing devices other than the particular computing device.

Inference(s) and/or prediction(s) 1150 can include output data produced by trained machine learning model(s) 1132 operating on input data 1130 (and training data 1110). In some examples, trained machine learning model(s) 1132 can use output inference(s) and/or prediction(s) 1150 as input feedback 1160. Trained machine learning model(s) 1132 can also rely on past inferences as inputs for generating new inferences.

Neural networks for training and/or inferencing can be examples of machine learning algorithm(s) 1120. After training, the trained version of neural networks for training and/or inference can be examples of trained machine learning model(s) 1132. In some examples, a given computing device can include the trained neural network for inferencing, perhaps after training the neural network for training.

In some examples, two or more computing devices can be used to provide output predictions; e.g., a first computing device can generate and send requests to predict to a second computing device. Then, the second computing device can use the trained versions of neural networks, perhaps after training, to generate a prediction, and respond to the requests from the first computing device. Then, upon reception of responses to the requests, the first computing device can provide the requested output (e.g., using a user interface and/or a display, a printed copy, an electronic communication, etc.).

### Computing Device Architecture

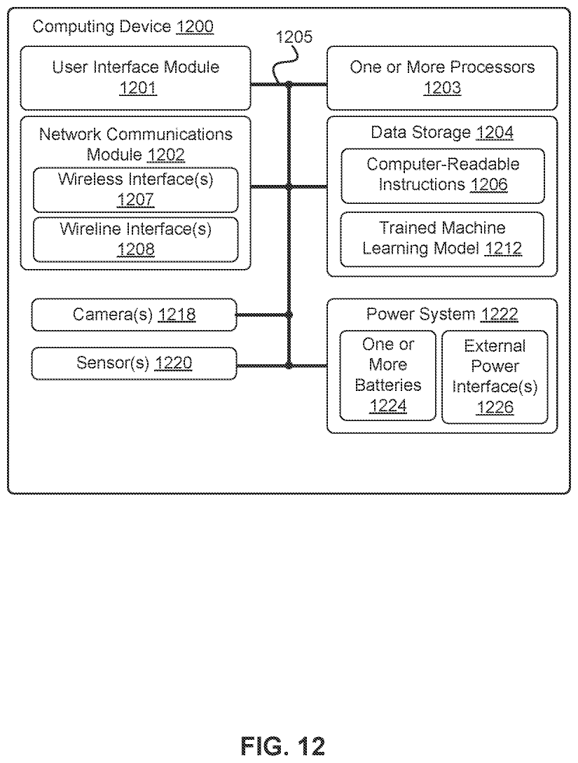

FIG. 12 is a block diagram of an example computing device 1200, in accordance with example embodiments. In particular, computing device 1200 shown in FIG. 12 can be configured to perform at least one function of and/or related to training phase 1102, inference phase 1104, and/or method 200, and/or method 1500.

Computing device 1200 may include a user interface module 1201, a network communications module 1202, one or more processors 1203, data storage 1204, one or more cameras 1218, one or more sensors 1220, and power system 1222, all of which may be linked together via a system bus, network, or other connection mechanism 1205.

User interface module 1201 can be operable to send data to and/or receive data from external user input/output devices. For example, user interface module 1201 can be configured to send and/or receive data to and/or from user input devices such as a touch screen, a computer mouse, a keyboard, a keypad, a touch pad, a trackball, a joystick, a voice recognition module, and/or other similar devices. User interface module 1201 can also be configured to provide output to user display devices, such as one or more cathode ray tubes (CRT), liquid crystal displays, light emitting diodes (LEDs), displays using digital light processing (DLP) technology, printers, light bulbs, and/or other similar devices, either now known or later developed. User interface module 1201 can also be configured to generate audible outputs, with devices such as a speaker, speaker jack, audio output port, audio output device, earphones, and/or other similar devices. User interface module 1201 can further be configured with one or more haptic devices that can generate haptic outputs, such as vibrations and/or other outputs detectable by touch and/or physical contact with computing device 1200. In some examples, user interface module 1201 can be used to provide a graphical user interface (GUI) for utilizing computing device 1200. For example, user interface module 1201 can be used to provide selectable objects in a video, where the selectable objects are identified as sources of on-screen audio. Also, for example, user interface module 1201 can be used to receive user input indicating selection of an on-screen object.

Network communications module 1202 can include one or more devices that provide one or more wireless interfaces 1207 and/or one or more wireline interfaces 1208 that are configurable to communicate via a network. Wireless interface(s) 1207 can include one or more wireless transmitters, receivers, and/or transceivers, such as a Bluetooth™ transceiver, a Zigbee® transceiver, a Wi-Fi™ transceiver, a WiMAX™ transceiver, an LTE™ transceiver, and/or other type of wireless transceiver configurable to communicate via a wireless network. Wireline interface(s) 1208 can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some examples, network communications module 1202 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

One or more processors 1203 can include one or more general purpose processors, and/or one or more special purpose processors (e.g., digital signal processors, tensor processing units (TPUs), graphics processing units (GPUs), application specific integrated circuits, etc.). One or more processors 1203 can be configured to execute computer-readable instructions 1206 that are contained in data storage 1204 and/or other instructions as described herein.

Data storage 1204 can include one or more non-transitory computer-readable storage media that can be read and/or accessed by at least one of one or more processors 1203. The one or more computer-readable storage media can include volatile and/or non-volatile storage components, such as optical, magnetic, organic or other memory or disc storage, which can be integrated in whole or in part with at least one of one or more processors 1203. In some examples, data storage 1204 can be implemented using a single physical device (e.g., one optical, magnetic, organic or other memory or disc storage unit), while in other examples, data storage 1204 can be implemented using two or more physical devices.

Data storage 1204 can include computer-readable instructions 1206 and perhaps additional data. In some examples, data storage 1204 can include storage required to perform at least part of the herein-described methods, scenarios, and techniques and/or at least part of the functionality of the herein-described devices and networks. In some examples, data storage 1204 can include storage for a trained neural network model 1212 (e.g., a model of trained neural networks). In particular of these examples, computer-readable instructions 1206 can include instructions that, when executed by processor(s) 1203, enable computing device 1200 to provide for some or all of the functionality of trained neural network model 1212.

In some examples, computing device 1200 can include one or more cameras 1218. Camera(s) 1218 can include one or more image capture devices, such as still and/or video cameras, equipped to capture videos. The one or more images can be one or more images utilized in video imagery. Camera(s) 1218 can capture light and/or electromagnetic radiation emitted as visible light, infrared radiation, ultraviolet light, and/or as one or more other frequencies of light.

In some examples, computing device 1200 can include one or more sensors 1220. Sensors 1220 can be configured to measure conditions within computing device 1200 and/or conditions in an environment of computing device 1200 and provide data about these conditions. For example, sensors 1220 can include one or more of: (i) sensors for obtaining data about computing device 1200, such as, but not limited to, a thermometer for measuring a temperature of computing device 1200, a battery sensor for measuring power of one or more batteries of power system 1222, and/or other sensors measuring conditions of computing device 1200; (ii) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (iii) sensors to measure locations and/or movements of computing device 1200, such as, but not limited to, a tilt sensor, a gyroscope, an accelerometer, a Doppler sensor, a GPS device, a sonar sensor, a radar device, a laser-displacement sensor, and a compass; (iv) an environmental sensor to obtain data indicative of an environment of computing device 1200, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor and/or a smoke sensor; and/or (v) a force sensor to measure one or more forces (e.g., inertial forces and/or G-forces) acting about computing device 1200, such as, but not limited to one or more sensors that measure: forces in one or more dimensions, torque, ground force, friction, and/or a zero moment point (ZMP) sensor that identifies ZMPs and/or locations of the ZMPs. Many other examples of sensors 1220 are possible as well.

Power system 1222 can include one or more batteries 1224 and/or one or more external power interfaces 1226 for providing electrical power to computing device 1200. Each battery of the one or more batteries 1224 can, when electrically coupled to the computing device 1200, act as a source of stored electrical power for computing device 1200. One or more batteries 1224 of power system 1222 can be configured to be portable. Some or all of one or more batteries 1224 can be readily removable from computing device 1200. In other examples, some or all of one or more batteries 1224 can be internal to computing device 1200, and so may not be readily removable from computing device 1200. Some or all of one or more batteries 1224 can be rechargeable. For example, a rechargeable battery can be recharged via a wired connection between the battery and another power supply, such as by one or more power supplies that are external to computing device 1200 and connected to computing device 1200 via the one or more external power interfaces. In other examples, some or all of one or more batteries 1224 can be non-rechargeable batteries.

One or more external power interfaces 1226 of power system 1222 can include one or more wired-power interfaces, such as a USB cable and/or a power cord, that enable wired electrical power connections to one or more power supplies that are external to computing device 1200. One or more external power interfaces 1226 can include one or more wireless power interfaces, such as a Qi wireless charger, that enable wireless electrical power connections, such as via a Qi wireless charger, to one or more external power supplies. Once an electrical power connection is established to an external power source using one or more external power interfaces 1226, computing device 1200 can draw electrical power from the external power source the established electrical power connection. In some examples, power system 1222 can include related sensors, such as battery sensors associated with the one or more batteries or other types of electrical power sensors.

### Example Data Network

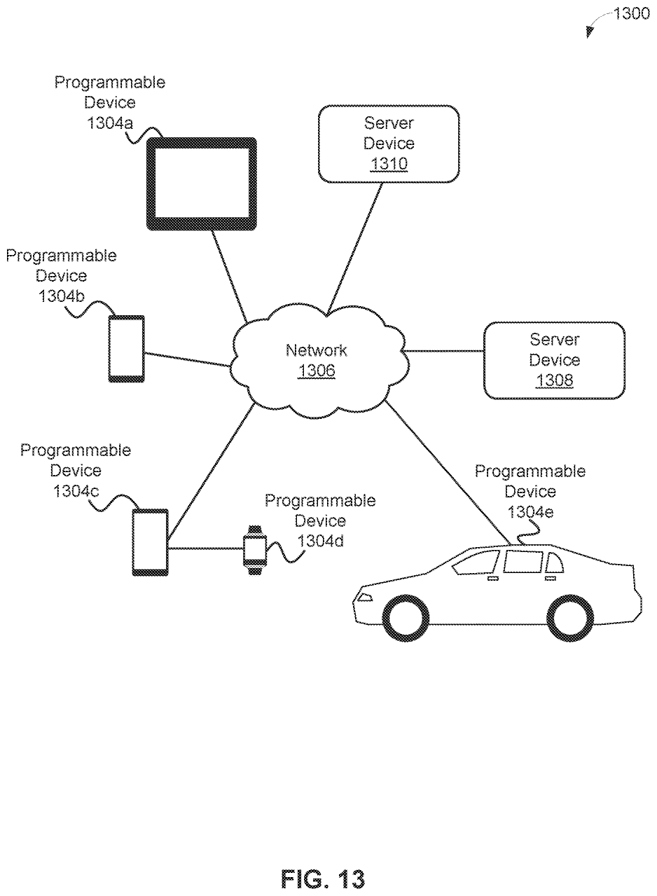

FIG. 13 depicts a distributed computing architecture 1300, in accordance with example embodiments. Distributed computing architecture 1300 includes server devices 1308, 1310 that are configured to communicate, via network 1306, with programmable devices 1304a, 1304b, 1304c, 1304d, 1304e. Network 1306 may correspond to a local area network (LAN), a wide area network (WAN), a WLAN, a WWAN, a corporate intranet, the public Internet, or any other type of network configured to provide a communications path between networked computing devices. Network 1306 may also correspond to a combination of one or more LANs, WANs, corporate intranets, and/or the public Internet.

Although FIG. 13 only shows five programmable devices, distributed application architectures may serve tens, hundreds, or thousands of programmable devices. Moreover, programmable devices 1304a, 1304b, 1304c, 1304d, 1304e (or any additional programmable devices) may be any sort of computing device, such as a mobile computing device, desktop computer, wearable computing device, head-mountable device (HMD), network terminal, a mobile computing device, and so on. In some examples, such as illustrated by programmable devices 1304a, 1304b, 1304c, 1304e, programmable devices can be directly connected to network 1306. In other examples, such as illustrated by programmable device 1304d, programmable devices can be indirectly connected to network 1306 via an associated computing device, such as programmable device 1304c. In this example, programmable device 1304c can act as an associated computing device to pass electronic communications between programmable device 1304d and network 1306. In other examples, such as illustrated by programmable device 1304e, a computing device can be part of and/or inside a vehicle, such as a car, a truck, a bus, a boat or ship, an airplane, etc. In other examples not shown in FIG. 13, a programmable device can be both directly and indirectly connected to network 1306.

Server devices 1308, 1310 can be configured to perform one or more services, as requested by programmable devices 1304a-1304e. For example, server device 1308 and/or 1310 can provide content to programmable devices 1304a-1304e. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 1308 and/or 1310 can provide programmable devices 1304a-1304e with access to software for database, search, computation, graphical, audio, video, World Wide Web/Internet utilization, and/or other functions. Many other examples of server devices are possible as well.

### Cloud-Based Servers

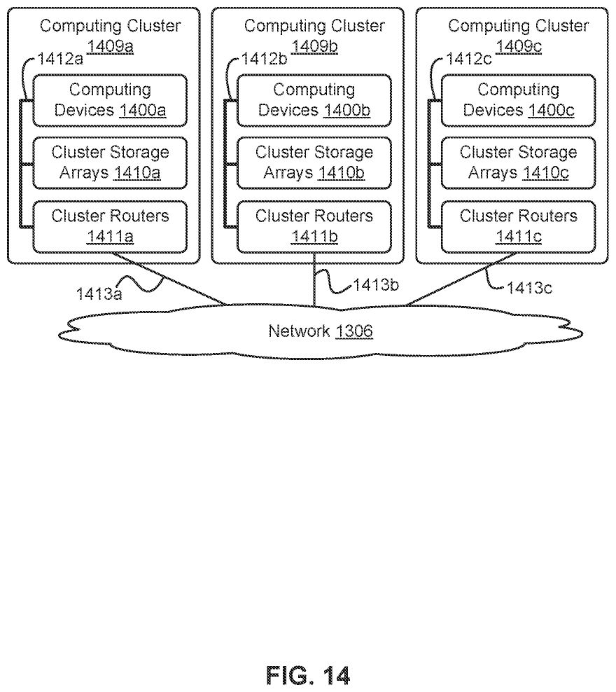

FIG. 14 depicts a network 1306 of computing clusters 1409a, 1409b, 1409c arranged as a cloud-based server system, in accordance with an example embodiment. Computing clusters 1409a, 1409b, 1409c can be cloud-based devices that store program logic and/or data of cloud-based applications and/or services; e.g., perform at least one function of and/or related to training phase 1202, inference phase 1204, and/or method 100.

In some embodiments, computing clusters 1409a, 1409b, 1409c can be a single computing device residing in a single computing center. In other embodiments, computing clusters 1409a, 1409b, 1409c can include multiple computing devices in a single computing center, or even multiple computing devices located in multiple computing centers located in diverse geographic locations. For example, FIG. 14 depicts each of computing clusters 1409a, 1409b, and 1409c residing in different physical locations.

In some embodiments, data and services at computing clusters 1409a, 1409b, 1409c can be encoded as computer readable information stored in non-transitory, tangible computer readable media (or computer readable storage media) and accessible by other computing devices. In some embodiments, computing clusters 1409a, 1409b, 1409c can be stored on a single disk drive or other tangible storage media, or can be implemented on multiple disk drives or other tangible storage media located at one or more diverse geographic locations.

FIG. 14 depicts a cloud-based server system in accordance with an example embodiment. In FIG. 14, functionality of training phase 1202, inference phase 1204, and/or a computing device can be distributed among computing clusters 1409a, 1409b, 1409c. Computing cluster 1409a can include one or more computing devices 1400a, cluster storage arrays 1410a, and cluster routers 1411a connected by a local cluster network 1412a. Similarly, computing cluster 1409b can include one or more computing devices 1400b, cluster storage arrays 1410b, and cluster routers 1411b connected by a local cluster network 1412b. Likewise, computing cluster 1409c can include one or more computing devices 1400c, cluster storage arrays 1410c, and cluster routers 1411c connected by a local cluster network 1412c.

In some embodiments, each of computing clusters 1409a, 1409b, and 1409c can have an equal number of computing devices, an equal number of cluster storage arrays, and an equal number of cluster routers. In other embodiments, however, each computing cluster can have different numbers of computing devices, different numbers of cluster storage arrays, and different numbers of cluster routers. The number of computing devices, cluster storage arrays, and cluster routers in each computing cluster can depend on the computing task or tasks assigned to each computing cluster.

In computing cluster 1409a, for example, computing devices 1400a can be configured to perform various computing tasks of a neural network, a classifier, and/or a computing device. In one embodiment, the various functionalities of a neural network, a classifier, and/or a computing device can be distributed among one or more of computing devices 1400a, 1400b, 1400c. Computing devices 1400b and 1400c in respective computing clusters 1409b and 1409c can be configured similarly to computing devices 1400a in computing cluster 1409a. On the other hand, in some embodiments, computing devices 1400a, 1400b, and 1400c can be configured to perform different functions.

In some embodiments, computing tasks and stored data associated with a neural network, a classifier, and/or a computing device can be distributed across computing devices 1400a, 1400b, and 1400c based at least in part on the processing requirements of a neural network, a classifier, and/or a computing device, the processing capabilities of computing devices 1400a, 1400b, 1400c, the latency of the network links between the computing devices in each computing cluster and between the computing clusters themselves, and/or other factors that can contribute to the cost, speed, fault-tolerance, resiliency, efficiency, and/or other design goals of the overall system architecture.

Cluster storage arrays 1410a, 1410b, 1410c of computing clusters 1409a, 1409b, 1409c can be data storage arrays that include disk array controllers configured to manage read and write access to groups of hard disk drives. The disk array controllers, alone or in conjunction with their respective computing devices, can also be configured to manage backup or redundant copies of the data stored in the cluster storage arrays to protect against disk drive or other cluster storage array failures and/or network failures that prevent one or more computing devices from accessing one or more cluster storage arrays.

Similar to the manner in which the functions of a neural network, a classifier, and/or a computing device can be distributed across computing devices 1400a, 1400b, 1400c of computing clusters 1409a, 1409b, 1409c, various active portions and/or backup portions of these components can be distributed across cluster storage arrays 1410a, 1410b, 1410c. For example, some cluster storage arrays can be configured to store one portion of the data of a neural network, a classifier, and/or a computing device, while other cluster storage arrays can store other portion(s) of data of a neural network, a classifier, and/or a computing device. Also, for example, some cluster storage arrays can be configured to store the data of a first neural network, while other cluster storage arrays can store the data of a second and/or third neural network. Additionally, some cluster storage arrays can be configured to store backup versions of data stored in other cluster storage arrays.

Cluster routers 1411a, 1411b, 1411c in computing clusters 1409a, 1409b, 1409c can include networking equipment configured to provide internal and external communications for the computing clusters. For example, cluster routers 1411a in computing cluster 1409a can include one or more internet switching and routing devices configured to provide (i) local area network communications between computing devices 1400a and cluster storage arrays 1410a via local cluster network 1412a, and (ii) wide area network communications between computing cluster 1409a and computing clusters 1409b and 1409c via wide area network link 1413a to network 1306. Cluster routers 1411b and 1411c can include network equipment similar to cluster routers 1411a, and cluster routers 1411b and 1411c can perform similar networking functions for computing clusters 1409b and 1409b that cluster routers 1411a perform for computing cluster 1409a.

In some embodiments, the configuration of cluster routers 1411a, 1411b, 1411c can be based at least in part on the data communication requirements of the computing devices and cluster storage arrays, the data communications capabilities of the network equipment in cluster routers 1411a, 1411b, 1411c, the latency and throughput of local cluster networks 1412a, 1412b, 1412c, the latency, throughput, and cost of wide area network links 1413a, 1413b, 1413c, and/or other factors that can contribute to the cost, speed, fault-tolerance, resiliency, efficiency and/or other design criteria of the moderation system architecture.

### Example Methods of Operation

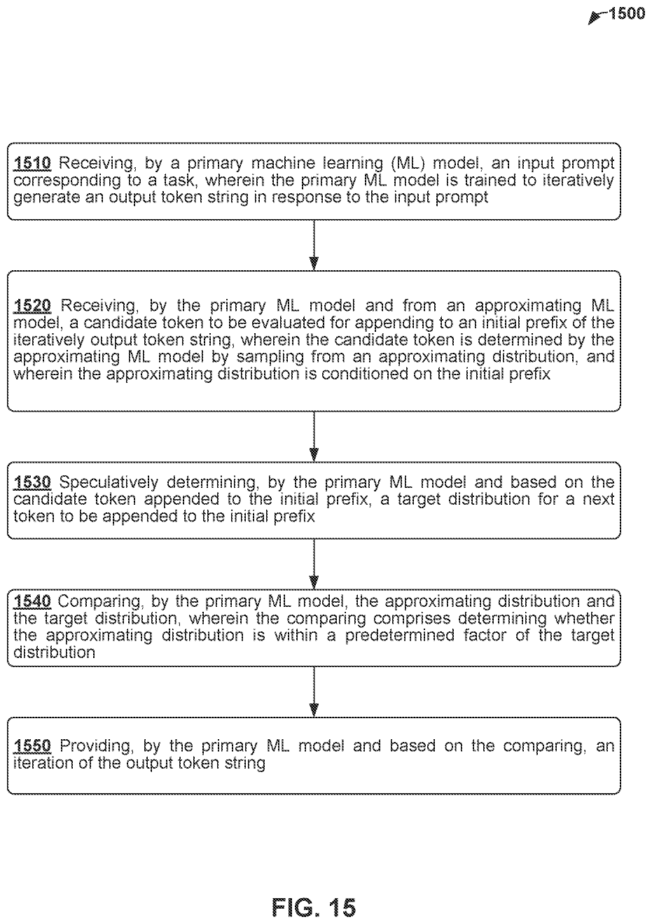

FIG. 15 illustrates an example method 1500 in a flowchart, in accordance with example embodiments. At block 1510, the method involves receiving, by a primary machine learning (ML) model, an input prompt corresponding to a task, wherein the primary ML model is trained to iteratively generate an output token string in response to the input prompt.

At block 1520, the method involves receiving, by the primary ML model and from an approximating ML model, a candidate token to be evaluated for appending to an initial prefix of the iteratively output token string, wherein the candidate token is determined by the approximating ML model by sampling from an approximating distribution, and wherein the approximating distribution is conditioned on the initial prefix.

At block 1530, the method involves speculatively determining, by the primary ML model and based on the candidate token appended to the initial prefix, a target distribution for a next token to be appended to the initial prefix.

At block 1540, the method involves comparing, by the primary ML model, the approximating distribution and the target distribution, wherein the comparing involves determining whether the approximating distribution is within a predetermined factor of the target distribution.

At block 1550, the method involves providing, by the primary ML model and based on the comparing, an iteration of the output token string.

Some embodiments involve accepting, by the primary ML model and based on a determination that the approximating distribution is within the predetermined factor of the target distribution, the candidate token as the next token. The providing of the iteration of the iteratively output token string involves providing the initial prefix appended with the next token.

Some embodiments involve rejecting, by the primary ML model and based on a determination that the approximating distribution is not within the predetermined factor of the target distribution, the candidate token as the next token.

Some embodiments involve receiving, by the primary ML model and from the approximating ML model, another candidate token to be evaluated for appending to the initial prefix, wherein the other candidate token is determined by the approximating ML model by sampling from an adjusted approximating distribution, wherein the adjusted approximating distribution is based on a difference between the approximating distribution and the target distribution. Such embodiments involve speculatively determining, by the primary ML model and based on the other candidate token appended to the initial prefix, a modified target distribution. Such embodiments involve comparing, by the primary ML model, the adjusted approximating distribution and the modified target distribution, wherein the comparing comprises determining whether the adjusted approximating distribution is within the predetermined factor of the modified target distribution. Such embodiments involve accepting, by the primary ML model and based on a determination that the adjusted approximating distribution is within the predetermined factor of the target distribution, the other candidate token as the next token.

Some embodiments involve receiving, by the primary ML model and from the approximating ML model, a second candidate token, wherein the second candidate token is sampled from a second approximating distribution, and wherein the second approximating distribution is conditioned on the initial prefix appended with the candidate token. Such embodiments involve speculatively determining, by the primary ML model and based on the initial prefix appended with the candidate token and the second candidate token, a second target distribution for another next token for another iteration of the iteratively output token. Such embodiments involve performing, by the primary ML model, a second comparing of the second approximating distribution and the second target distribution, wherein the second comparing comprises determining whether the second approximating distribution is within the predetermined factor of the second target distribution. The providing of the iteration of the iteratively output token string involves providing, based on the second comparing, the other iteration of the iteratively output token.

In some embodiments, the comparing involves determining that the approximating distribution is smaller than the target distribution or identical to the target distribution. Such embodiments involve accepting, by the primary ML model and based on a determination that the approximating distribution is smaller than the target distribution or identical to the target distribution, the candidate token as the next token to be appended to the initial prefix.

In some embodiments, the comparing involves determining that the approximating distribution is greater than the target distribution. Such embodiments involve rejecting the candidate token as the next token. Such embodiments involve determining an additional distribution based on a difference between the approximating distribution and the target distribution. Such embodiments involve sampling, based on the additional distribution, another candidate token to be evaluated for appending to the initial prefix. Such embodiments involve accepting or rejecting the other candidate token as the next token based on the additional distribution.

Some embodiments involve determining a terminal token based on a terminal token distribution. The providing of the iteration of the iteratively output token string involves appending the terminal token to terminate the output token string.

In some embodiments, the one or more of the approximating ML model or the primary ML model may be an autoregressive model. In some embodiments, the autoregressive model may be a transformer model.

In some embodiments, the approximating ML model may be a non-autoregressive model.

In some embodiments, the candidate token may be one of: (i) a start output indicator, (ii) a word from a natural language, (iii) a whitespace indicator, or (iv) an end output indicator.

In some embodiments, the primary ML model includes a first number of model parameters, and the approximating ML model includes a second number of model parameters. The first number may be greater than the second number.

In some embodiments, the task may be a language modeling task. In some embodiments, the language modeling task may be a translation task involving translating an input phrase from a first language to a second language.

Some embodiments involve receiving, by the primary ML model and from the approximating ML model, a plurality of additional candidate tokens sampled from a respective plurality of additional approximating distributions. Such embodiments involve speculatively determining, in parallel and by the primary ML model, a respective plurality of additional target distributions based on appending to the initial prefix, one or more additional candidate tokens selected at random from the plurality of additional candidate tokens. Such embodiments involve performing, in parallel and by the primary ML model, additional comparisons of the plurality of additional approximating distributions and the respective plurality of additional target distributions. Such embodiments involve providing, by the primary ML model and based on the additional comparisons, another iteration of the iteratively output token string.

In some embodiments, the sampling from the approximating distribution may be based on one of argmax sampling, top-k sampling, nucleus sampling, or setting-a-temperature sampling.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

1. A computer-implemented method, comprising:
receiving, by a primary machine learning (ML) model, an input prompt corresponding to a task, wherein the primary ML model is trained to iteratively generate an output token string in response to the input prompt;
receiving, by the primary ML model and from an approximating ML model, a candidate token to be evaluated for appending to an initial prefix of the iteratively output token string, wherein the candidate token is determined by the approximating ML model by sampling from an approximating distribution, and wherein the approximating distribution is conditioned on the initial prefix;
speculatively determining, by the primary ML model and based on the candidate token appended to the initial prefix, a target distribution for a next token to be appended to the initial prefix;
comparing, by the primary ML model, the approximating distribution and the target distribution, wherein the comparing comprises determining whether the approximating distribution is within a predetermined factor of the target distribution; and
providing, by the primary ML model and based on the comparing, an iteration of the output token string.

2. The computer-implemented method of claim 1, further comprising:
accepting, by the primary ML model and based on a determination that the approximating distribution is within the predetermined factor of the target distribution, the candidate token as the next token, and
wherein the providing of the iteration of the iteratively output token string comprises providing the initial prefix appended with the next token.

3. The computer-implemented method of claim 1, further comprising:
rejecting, by the primary ML model and based on a determination that the approximating distribution is not within the predetermined factor of the target distribution, the candidate token as the next token.

4. The computer-implemented method of claim 1, further comprising:
receiving, by the primary ML model and from the approximating ML model, another candidate token to be evaluated for appending to the initial prefix, wherein the other candidate token is determined by the approximating ML model by sampling from an adjusted approximating distribution, wherein the adjusted approximating distribution is based on a difference between the approximating distribution and the target distribution;
speculatively determining, by the primary ML model and based on the other candidate token appended to the initial prefix, a modified target distribution;
comparing, by the primary ML model, the adjusted approximating distribution and the modified target distribution, wherein the comparing comprises determining whether the adjusted approximating distribution is within the predetermined factor of the modified target distribution; and
accepting, by the primary ML model and based on a determination that the adjusted approximating distribution is within the predetermined factor of the target distribution, the other candidate token as the next token.

5. The computer-implemented method of claim 1, wherein the primary ML model is run in parallel with the approximating ML model, and further comprising:
receiving, by the primary ML model and from the approximating ML model, a second candidate token, wherein the second candidate token is sampled from a second approximating distribution, and wherein the second approximating distribution is conditioned on the initial prefix appended with the candidate token;
speculatively determining, by the primary ML model and based on the initial prefix appended with the candidate token and the second candidate token, a second target distribution for another next token for another iteration of the iteratively output token;
performing, by the primary ML model, a second comparing of the second approximating distribution and the second target distribution, wherein the second comparing comprises determining whether the second approximating distribution is within a predetermined factor of the second target distribution, and
wherein the providing of the iteration of the iteratively output token string comprises providing, based on the second comparing, the other iteration of the iteratively output token.

6. The computer-implemented method of claim 1, wherein the comparing comprises determining that the approximating distribution is smaller than the target distribution or identical to the target distribution, and further comprising:
accepting, by the primary ML model and based on a determination that the approximating distribution is smaller than the target distribution or identical to the target distribution, the candidate token as the next token to be appended to the initial prefix.

7. The computer-implemented method of claim 1, wherein the comparing comprises determining that the approximating distribution is greater than the target distribution, and further comprising:
rejecting the candidate token as the next token;
determining an additional distribution based on a difference between the approximating distribution and the target distribution;
sampling, based on the additional distribution, another candidate token to be evaluated for appending to the initial prefix; and
accepting or rejecting the other candidate token as the next token based on the additional distribution.

8. The computer-implemented method of claim 1, further comprising:
determining a terminal token based on a terminal token distribution, and
wherein the providing of the iteration of the iteratively output token string comprises appending the terminal token to terminate the output token string.

9. The computer-implemented method of claim 1, wherein the one or more of the approximating ML model or the primary ML model is an autoregressive model.

10. The computer-implemented method of claim 9, wherein the autoregressive model is a transformer model.

11. The computer-implemented method of claim 1, wherein the approximating ML model is a non-autoregressive model.

12. The computer-implemented method of claim 1, wherein the candidate token is one of: (i) a start output indicator, (ii) a word from a natural language, (iii) a whitespace indicator, or (iv) an end output indicator.

13. The computer-implemented method of claim 1, wherein the primary ML model comprises a first number of model parameters, and the approximating ML model comprises a second number of model parameters, wherein the first number is greater than the second number.

14. The computer-implemented method of claim 1, wherein the task is one or more of a language modeling task, a text generation task, or a multimodal sequence generation task.

15. The computer-implemented method of claim 14, wherein the language modeling task is a translation task comprising translating an input phrase from a first language to a second language.

16. The computer-implemented method of claim 1, further comprising:
receiving, by the primary ML model and from the approximating ML model, a plurality of additional candidate tokens sampled from a respective plurality of additional approximating distributions;
speculatively determining, in parallel and by the primary ML model, a respective plurality of additional target distributions based on appending to the initial prefix, one or more additional candidate tokens selected at random from the plurality of additional candidate tokens;
performing, in parallel and by the primary ML model, additional comparisons of the plurality of additional approximating distributions and the respective plurality of additional target distributions; and
providing, by the primary ML model and based on the additional comparisons, another iteration of the iteratively output token string.

17. The computer-implemented method of claim 1, wherein the sampling from the approximating distribution is based on one of argmax sampling, top-k sampling, nucleus sampling, or setting-a-temperature sampling.

18. A system, comprising:
a primary machine learning (ML) model configured to iteratively generate an output token string in response to the input prompt corresponding to a task;
an approximating ML model;
a processor; and
data storage, wherein the data storage has stored thereon computer-executable instructions that, when executed by the processor, cause the system to carry out functions comprising:
receiving, by the primary ML model, the input prompt corresponding to the task;
determining, by the approximating ML model, an approximating distribution conditioned on an initial prefix of the iteratively output token string;
determining, by the approximating ML model and by sampling from the approximating distribution, a candidate token to be evaluated for appending to the initial prefix;
speculatively determining, by the primary ML model and based on the candidate token appended to the initial prefix, a target distribution for a next token to be appended to the initial prefix;
comparing, by the primary ML model, the approximating distribution and the target distribution, wherein the comparing comprises determining whether the approximating distribution is within the predetermined factor of the target distribution; and
providing, by the primary ML model and based on the comparing, an iteration of the output token string.

19. A computing device, comprising:
one or more processors; and
data storage, wherein the data storage has stored thereon computer-executable instructions that, when executed by the one or more processors, cause the computing device to carry out functions comprising:
receiving, by a primary machine learning (ML) model, an input prompt corresponding to a task, wherein the primary ML model is trained to iteratively generate an output token string in response to the input prompt;
receiving, by the primary ML model and from an approximating ML model, a candidate token to be evaluated for appending to an initial prefix of the iteratively output token string, wherein the candidate token is determined by the approximating ML model by sampling from an approximating distribution, and wherein the approximating distribution is conditioned on the initial prefix;
speculatively determining, by the primary ML model and based on the candidate token appended to the initial prefix, a target distribution for a next token to be appended to the initial prefix;
comparing, by the primary ML model, the approximating distribution and the target distribution, wherein the comparing comprises determining whether the approximating distribution is within a predetermined factor of the target distribution; and
providing, by the primary ML model and based on the comparing, an iteration of the output token string.

20. The computing device of claim 19, wherein the computing device is a mobile device.

21. (canceled)

22. (canceled)

23. (canceled)
